(19) United States
(12) Patent Application Publication
(10) Pub. No.: US 2002/0130840 A1
(43) Pub. Date: Sep. 19, 2002

(54) Integrated recorder

(76) Inventor: Michael Borell, Miami, FL (US)

Correspondence Address: Michael A. Slavin, McHale & Slavin, P.A., 4440 PGA Blvd., Suite 402, Palm Beach Gardens, FL, 33410, US

(21) Appl. No.: 09/809,796

(22) Filed: Mar. 16, 2001

(51) Int. Cl. G10L 15/00; G09G 5/08; G09G 5/00; B68G 5/00

(52) U.S. Cl. 345/163; 345/156; 248/118

(57) ABSTRACT

The instant invention is a mouse or a mouse pad having an integrated digital recorder which allows an individual to leave a brief message such as a website address location. The message can be recorded automatically, by voice activation, or manually by an on/off switch.

### FIELD OF THE INVENTION

This invention relates to the field of computers, and more specifically, to a computer mouse pad or mouse incorporating a recorder upon wherein paperless notes can be temporarily stored.

### BACKGROUND OF THE INVENTION

The advent of desktop computers would appear to provide the ultimate in desktop organization. Desktop computers are capable of preparing simple letters or calculating complex algorithms making desktop computers an indispensable tools. The development of the mouse, which provides translational movement of a cursor in response to the rotational movement of a trackball, has further simplified computers making them usable by most any individual.

One of the most common uses of computers today is for accessing the Internet. The Internet is a network of computers based on standard protocols that allow computers to communicate with each other even if using different software vendors, thus allowing anyone with a computer has accessibility to anything else connected to the Internet worldwide. Interconnected computers may exchange information using various services, for example, the worldwide web (WWW). The WWW is a structure which allows users seeking information on the Internet to switch from server to server. The WWW structure allows a server computer system (web server or web site) to send graphical web pages of information to a remote client computer system. A program known as a web browser running on a client computer allows the client computer to communicate with the WWW. The remote clients' computer system can then display the web pages.

A problem with computer usage, to which the invention addresses, is the need to remember items on a very temporary basis. For instance, Internet browsing may include the need for an individual to temporarily remember a website location or [symbol] address. [symbol] By way of example, an Internet search may reveal a number of addresses for locations that provide patent related items (e.g. [symbol] www.uspto.gov [symbol] ). An individual may wish to view the PTO site after checking out some other sites, however, the individual must remember the address or retrace their steps if a viewing of the site is to occur. So as not to lose the website address, the individual may make a note of the address on scrape paper or a note pad. In this scenario, the individual must pause during the search to write down the address and make note of reason for the address. This is a time consuming process and makes it a disadvantage for business people who need only make note of an address for a few minutes. Non-business people also find a lack of need to record every address. The use of paper for the temporary recording of such address adds to, if not creates, the clutter of a work space thereby defeating one of the objectives of a computer, that is, to achieve a paperless office.

U.S. Pat. No. 5,405,168 discloses a mouse pad that also operates as a note pad. While this patent discloses the basic need for temporary storage of matters in relation to a mouse pad, it is well known that an writing on a mouse pad can quickly cause problems with the operation of the mouse trackball.

Thus, what is lacking in the art is a means for note taking particularly directed to the use of address note taking while browsing the Internet.

### SUMMARY OF THE INVENTION

The instant invention is a mouse or a mouse pad having an integrated digital recorder which allows an individual to leave a brief message such as to the details of a website address. The recording mechanism has an audio controller with an audio data memory connected to and under the control of the audio controller. A speaker is connected to and coupled to the audio controller, a switch connected to the audio controller such that when an operation switch is activated the audio controller retrieves audio data from the audio data memory and outputs audio data to the speaker.

Thus, an objective of an instant invention is to eliminate the need for hand written notes for the temporarily recording of Internet website addresses.

Yet another objective of the instant invention is to provide a recording device that allows an individual to record a message such as that found on a computer without taking the individuals eyes away from the computer during the recording of the message, thereby lessening the chance for inaccuracies.

Yet still another objective of the instant invention is to eliminate the need for handwritten notes used for temporary storage.

Still another objective of the invention is to integrate a recording device into a computer mouse pad that is further used as a platform for a computer mouse.

Yet still another objective of the invention is to integrate a recording device into a computer mouse.

Other objectives and advantages of this invention will become apparent from the following description taken in conjunction with the accompanying drawings wherein are set forth, by way of illustration and example, certain embodiments of this invention. The drawings constitute a part of this specification and include exemplary embodiments of the present invention and illustrate various objects and features thereof.

### BRIEF DESCRIPTION OF THE DRAWINGS

FIG. 1 is a pictorial view of a computer mouse pad with an integrated digital recorder;

FIG. 2 is a diagrammatic representation of a digital recorder; and

FIG. 3 is a perspective view of a computer mouse having an integrated digital recorder.

### DESCRIPTION OF THE PREFERRED EMBODIMENT

Although the invention will be described in terms of a specific embodiment, it will be readily apparent to those skilled in this art that various modifications, rearrangements and substitutions can be made without departing from the spirit of the invention. The scope of the invention is defined by the claims appended hereto.

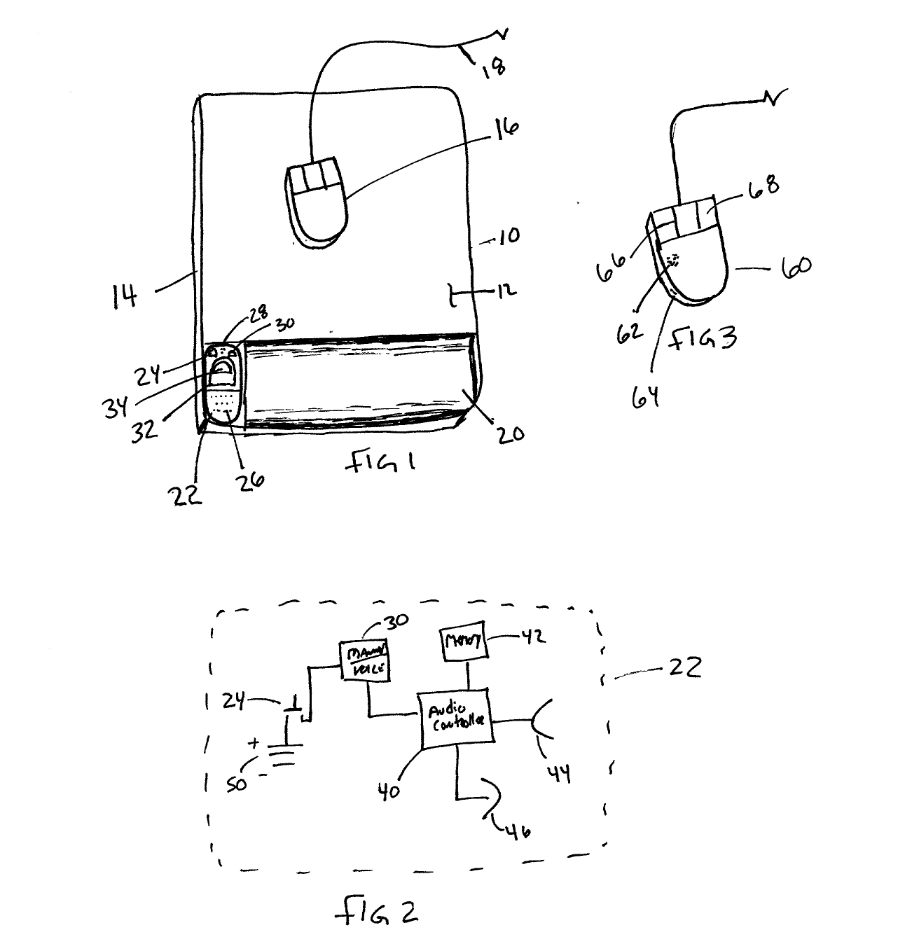

Referring now to FIG. 1, set forth is a computer mouse pad 10 formed from a sheet of material having a top face 12, a bottom face, not shown, and opposing side edges 14. Said top face 12 having a texture for engaging of a mouse 16 track ball. The mouse 16 is moveable along the top face 12 of the pad 10 wherein rotation of the track ball results provides the appropriate signal carried by coupling cord 18 for translation movement of a display cursor. The pad 10 may also include a wrist rest 20 that is raised a height above the top face 12.

Mounted or formed integral to the pad 10 is a recorder 22 having an on/off switch 24 for providing power to the recorder. A speaker grill 26 shields a speaker cone and a microphone grill 28 shields a microphone. A manual/voice activation switch 30 allows the recordation to be performed automatically upon receipt of voice commands or manually by depressing a record/playback face plate 32. The face plate 32 further allows playback of a previously made recording by activation of a playback cycle. An optional display screen 34 provides visual indication of battery life, recording action, and audio data memory remaining.

Referring to FIG. 2 the recorder 22 includes the power switch 24 which is coupled to the manual/voice activation switch 30 an audio controller 40. Audio controller 40 controls data memory 42, speaker 44 and microphone 46. The audio controller 40 includes circuitry necessary to receive analog audio data from microphone 46, an analog to digital (A/D) converter and associated circuitry to convert and store data into data memory 42, a digital to analog (D/A) converter and associated circuitry to retrieve digital data and converter it to audio data, and an amplifier to amplify the audio data and play it on speaker 44 A/D converters, D/A converters, and amplifiers are well known in the art. Battery 50 is attached to audio controller 40 and provides power for operation of the device.

Data memory 42 is a digital audio memory device. Digital audio memory is well known in the art and commercially available from numerous vendors. Those skilled in the art will recognize that alternative memory technologies, such as magnetic tape, can be implemented. However, these technologies have the disadvantages associated with any device that has moving parts.

In the preferred embodiment, when an individual depresses switch 24, audio controller 40 activates microphone 46. Audio data from microphone 46 is input into audio controller 40 where it is converted to digital data and stored in data memory 42, converts it to analog audio data and outputs it to speaker 44. If the mouse pad is a disposable device, then battery 50 would not be replaceable. For reusable embodiments, battery 50 would be replaceable.

Referring to FIG. 3, set forth is a second embodiment of the invention wherein a mouse 60 includes the recordation device. In this embodiment, the mouse has a speaker grill 62 and a microphone grill 64. A manual/voice activation switch can be programmed into the toggle button 66 for left handed individuals, or into toggle button 68 for right handed individuals. In this manner, the mouse can be used in its typical manner with recordation can be performed automatically upon receipt of voice commands or manually by double clicking the same toggle button.

As with the first embodiment, the recordation mouse will include an audio controller which controls data memory, speaker and a microphone. The audio controller includes circuitry necessary to receive analog audio data from microphone, an analog to digital (A/D) converter and associated circuitry to convert and store data into data memory, a digital to analog (D/A) converter and associated circuitry to retrieve digital data and converter it to audio data, and an amplifier to amplify the audio data and play it on the speaker, A/D converters, D/A converters, and amplifiers are well known in the art. Power is obtained from the power cord that controls the mouse.

It is to be understood that while I have illustrated and described certain forms of my invention, it is not to be limited to the specific forms or arrangement of parts herein described and shown. It will be apparent to those skilled in the art that various changes may be made without departing from the scope of the invention and the invention is not to be considered limited to what is shown in the drawings and described in the specification.

What I claim is:

1. A combination computer mouse pad and digital recorder, comprising:
at least one sheet of material having a top face, a bottom face and opposing side edges, said top face having a texture for engaging a track ball of a computer mouse;
an audio controller having a audio data memory connected to and under control of the audio controller; a speaker connected to and under control of the audio controller; and a switch connected to the audio controller such that when an operation switch is activated the audio controller retrieves audio data from the audio data memory and outputs audio data to the speaker.

2. The combination computer mouse pad and digital recorder according to claim 1 further comprising: a microphone having an audio output; an audio input in the audio controller for inputting audio data from the microphone; the audio controller further having means to write audio data input by the microphone into the audio data memory, means to read the audio data from the audio data memory and means to output audio data to the speaker; whereby a message can be recorded and played back.

3. The combination computer mouse pad and digital recorder according to claim 2 wherein the audio data is inputted from the microphone, recorded to the audio data memory, read from the audio data memory and output to the speaker when the switch is activated.

4. The combination computer mouse pad and digital recorder according to claim 1 wherein said operation switch is manually activated.

5. The combination computer mouse pad and digital recorder according to claim 1 wherein said operation switch is automatically activated by voice command to initiate audio recording and playback.

6. An integrated digital recorder, comprising:
a computer pointer device having a housing, said housing having a trackball and an audio controller, said audio controller having a audio data memory connected to and under control of the audio controller; a speaker connected to and under control of the audio controller; and a switch connected to the audio controller such that when an operation switch is activated the audio controller retrieves audio data from the audio data memory and outputs audio data to the speaker.

7. The integrated digital recorder according to claim 6 further comprising: a microphone having an audio output; an audio input in the audio controller for inputting audio data from the microphone; the audio controller further having means to write audio data input by the microphone into the audio data memory, means to read the audio data from the audio data memory and means to output audio data to the speaker; whereby a message can be recorded and played back.

8. The integrated digital recorder according to claim 7 wherein the audio data is input from the microphone, recorded to the audio data memory, read from the audio data memory and output to the speaker when the switch is activated.

9. The integrated digital recorder according to claim 6 wherein an operation switch is manually activated.

10. The integrated digital recorder according to claim 6 wherein the switch is automatically activated by voice command to initiate audio recording and playback.
